(19) United States
(12) Patent Application Publication
(10) Pub. No.: US 2009/0272447 A1
(43) Pub. Date: Nov. 5, 2009

(54) Grey Water Diversion Device

(76) Inventor: Robert H. Dvorak, Stoughton, WI (US)

Correspondence Address: MURPHY DESMOND S.C., P.O. BOX 2038, MADISON, WI, 53701-2038, US

(21) Appl. No.: 12/356,463

(22) Filed: Jan. 20, 2009

Related U.S. Application Data
(60) Provisional application No. 61/050,116, filed on May 2, 2008.

(51) Int. Cl. F15C 3/00

(52) U.S. Cl. 137/861

(57) ABSTRACT

The present invention is directed to a grey water diversion system. The diversion system that directs grey water from a fixture, such as a wash basin, sink, bathtub, or shower, to a sewer line or septic tank, to a reservoir, or to another fixture for use. The system consists of a structure inserted in line with the fixture's drain, whether directly affixed to the drain or to a pipe leading from the drain. The diversion device is controlled by the user of the fixture for instantaneous diversion of water to be sent to grey water use or storage or to be sent to a sewer system. The diversion system is meant to be able to be installed using the fixture of the operator's choice. This fixture may be new or the one currently installed. The fixture may be a standard fixture and need not be custom-made or special-ordered for use with the diversion system.

### RELATED APPLICATION

The present invention claims priority from U.S. Provisional Patent Application 61/050,116.

### BACKGROUND OF THE INVENTION

The present invention relates generally to grey water recycling systems and, more particularly, to drain and water diverters for grey water recycling and recirculating systems.

Any water that has been used in the home, except water from toilets, is called grey water. Grey water, including dish, shower, sink, and laundry water comprise 50-80% of residential “waste” water. Without a recycling or recirculation system, this water is generally lost to a sanitary sewer system by means of municipal or private discharge.

In the interest of conservation, grey water may be reused for other non-potable purposes to replace fresh water in many instances, saving money and increasing the effective water supply in regions where irrigation is needed. Most water could be recycled for both indoor and outdoor use, achieving the same result with significantly less water diverted from nature. Due to bacterial contamination, obvious exceptions include water from toilets and kitchen sinks that may contain food waste products. Recycling or recirculation systems divert the reusable water to reservoirs from which water may be drawn for non-potable purposes or to other fixtures that may use the grey water immediately.

For most purposes, grey water will be diverted to a reservoir. However, grey water also can be diverted to immediate uses such for watering plants. Similarly, waste or black water generally is directed to a sewer, but also may be directed to septic tanks and leach fields, etc.

Preferably, water may be diverted at the user's option, either to the holding reservoirs for reuse or to the sewer or other discharge destinations as waste. For instance, water which contains certain detergents or wastes is undesirable for reuse and would be diverted to the sewer. It is desirable for a user to have discretionary control over whether water should be diverted to the sewer system or to the reservoir at the instant that water is being used.

Current recycling or recirculation systems are complex, unwieldy, and difficult to retrofit into existing buildings or plans. Often non-standard plumbing fixtures, pipes, and components are necessary. In other recycling or recirculation systems, the retrofitted devices are unwieldy, complicated, and dramatically change the drainage of the fixture.

Current typical residential grey water systems will save an operator only small monthly amounts of freshwater. Therefore, it is important that any recycling or recirculation system's cost is kept low, including both the materials and installation costs. It is also important to keep the system simple so that the need for repairs is reduced and the repairs necessary are inexpensive and easily performed.

From the foregoing discussion, it is apparent that there is a need for a drain diversion system that can be placed in a recycling or recirculating system that can divert water into a reservoir or sewer system that uses common plumbing components, that can be used in current fixtures, and that does not result in an unwieldy or complex structure.

### BRIEF SUMMARY OF THE INVENTION

The present invention is a drain diversion system that directs grey water from a fixture, such as a wash basin, sink, bathtub, or shower, to a sewer line or septic tank, or to a reservoir, or to another fixture for reuse. The system consists of a structure inserted in line with the fixture's drain, whether directly affixed to the drain or to a pipe leading from the drain. The diversion device is controlled by the user of the fixture for instantaneous diversion of water for grey water use or storage or to be sent to a sewer or other waste system.

In one embodiment, the diversion device is a removable filter basket that fits into the drain hole of the fixture with a diversion piece at the bottom and a drain pipe with a divider. The drain basket consists of a recessed screen that sits inside a solid-wall cup that covers at least half of the outside of the screen and has an extension at the bottom that projects into the drain pipe below. The drain pipe has an opening directly under the drain basket. The extension may fill the entire cross-section of the drain pipe such that when the extension is perpendicular to the pipe, water flows in only one direction in the pipe, or the drain pipe may have a solid divider such that the extension of the drain cup directs draining water to only one side of the divider at a given time. The solid-walled cup may be rotated so that the extension may direct water to either side of the drain pipe divider. In an embodiment, water may only be diverted to one side of the divider at a time.

In another embodiment, the diversion device is a removable filter basket that fits into the drain hole of the fixture and a drain pipe with valves on either side of the filter basket. In this embodiment, the filter cup may or may not have any solid-wall components. On either side of the filter basket is a valve. Only one valve may be open at a time so that the water may be diverted in only one direction at any given time. In a further embodiment, the diverter comprises a first valve that regulates water flow in a first channel and a second valve that regulates water flow in a second channel, wherein when one valve is open, the other is closed, to such that water is substantially directed to only one channel at a time. In yet another embodiment, the diverter comprises a gate that alternatively directs water to a first or a second channel.

In another embodiment, the diversion device is a removable filter basket that fits into the drain hole of the fixture and a drain pipe with one valve preceded by a diverter pipe. In this embodiment, the water drains through the filter basket into a drain pipe. If the valve is open, the water continues through the drain pipe. If the valve is closed, the water is then forced into the diversion pipe. The diversion pipe precedes the valve and is joined to the drain pipe such that no water enters the diversion pipe unless and until the valve is closed.

### BRIEF DESCRIPTION OF THE DRAWINGS

FIG. 1 is a side sectional view of the fixture, piping, and filter assembly of the present invention according to one embodiment of the invention.

FIG. 2 is a detailed view of the selected section of FIG. 1.

FIG. 3 is an exploded perspective view of the filter assembly of FIGS. 1 and 2.

FIG. 4 is a side sectional view of the fixture, piping, and filter assembly of another embodiment of the present invention.

FIG. 5 is a side sectional view of the fixture, piping, and filter assembly of another embodiment of the present invention.

### DETAILED DESCRIPTION OF THE INVENTION

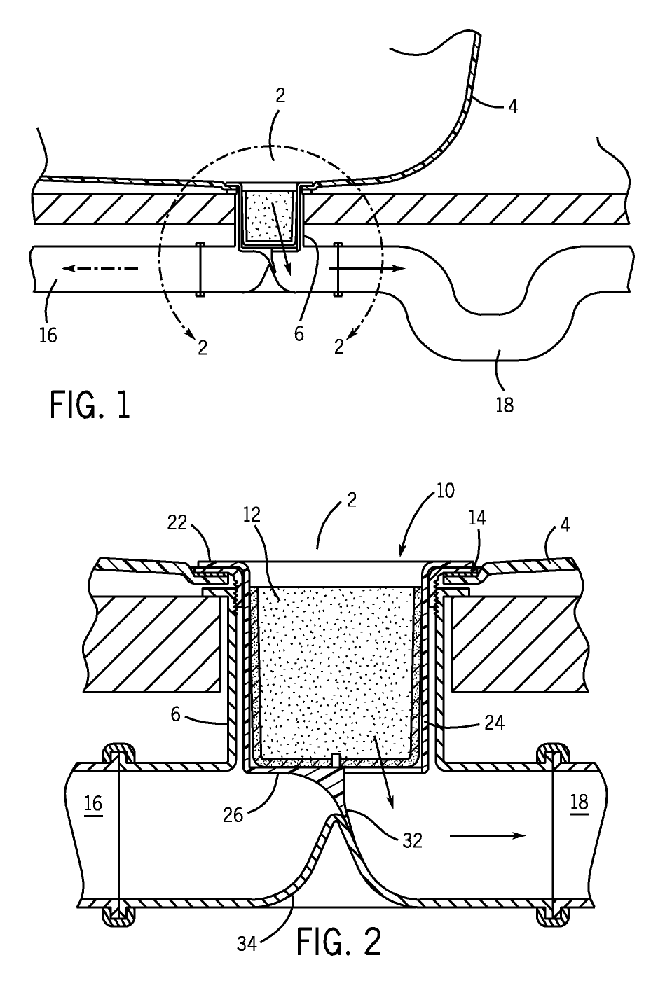

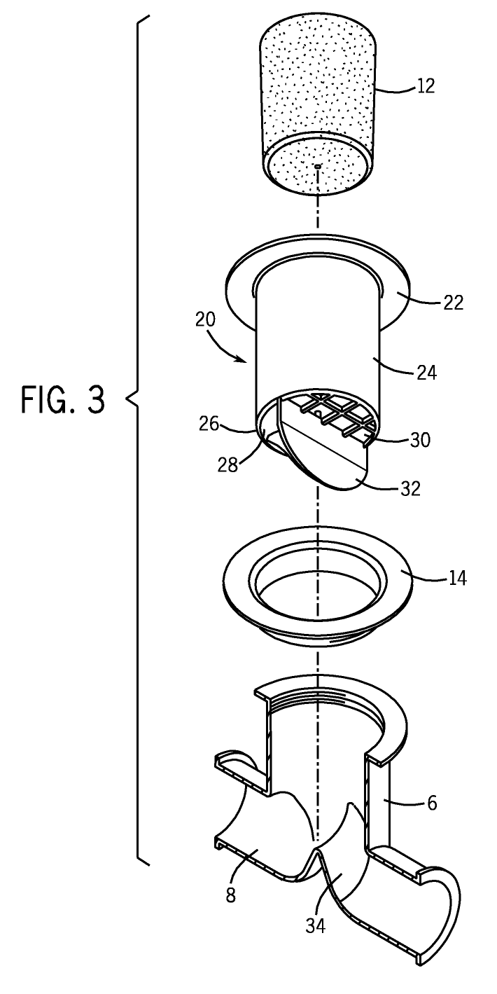

FIGS. 1, 2 and 3, illustrate one embodiment according to the invention installed in a fixture [4] with opening [2] located at the bottom of the fixture [4]. A connecting pipe [6] connects opening [2] to drain pipe [8] below the fixture [4]. Setting in the connecting pipe [6] is the filter apparatus [10]. The filter apparatus [10] comprises a filter basket [12], a filter holder [20], and a gasket [14]. The filter basket [12] fits snugly inside the filter holder [20] to trap debris in the filter, and to prevent debris from escaping between the filter basket [12] and filter holder [20]. The filter holder [20] is comprised of a lip [22], solid walls [24], and a floor [26] The gasket [14] seals the space between the lip [22] and the borders of the opening [2] to prevent water from escaping past the filter basket [20], which is smaller than opening [2]. The floor [26] of the filter holder [20] consists of two distinct sections. A solid section [28] and an outlet section [30] as shown in FIG. 3. The outlet section [30] may have further structural support to hold the filter basket [12], but it freely allows water to flow through. At the division of the separate sections is an extension [32] that extends into drain pipe [8] to meet a pipe divider [34] positioned directly below the filter apparatus [10] in drain pipe [8]. The extension [32] spans across the filter holder [20] to coincide with the division between the solid section [28] and outlet section [30]. The pipe divider [34] also spans across drain pipe [8]. The extension [32] and the pipe divider [34] cooperate together to block drain pipe [8] such that water may only flow in one direction at one time. When extension [32] is positioned on a side of the pipe divider [34] it directs the water through a first channel [16] of drain pipe [8]. To divert water in the other direction, the extension [32] is repositioned to direct water through a second channel [18] of the drain pipe [8].

The extension [32] can be made of either a hard material or a flexible material, both well-known in the plumbing art. If made out of a hard material, the filter apparatus [10] will need to be lifted over the pipe divider [34] to reposition the extension [32] to the other side of pipe divider [34]. In that embodiment, extension [32] must clear the pipe divider [34] before the filter apparatus [10] is rotated fully. If the extension [32] is made of a flexible material, the extension [32] may slide over the pipe divider [34] when the filter apparatus [10] is rotated. In this embodiment, there is no need to lift the filter apparatus [10]. The pipe divider [34] may be an additional piece that is added to a straight pipe or in may be a part of the pipe itself.

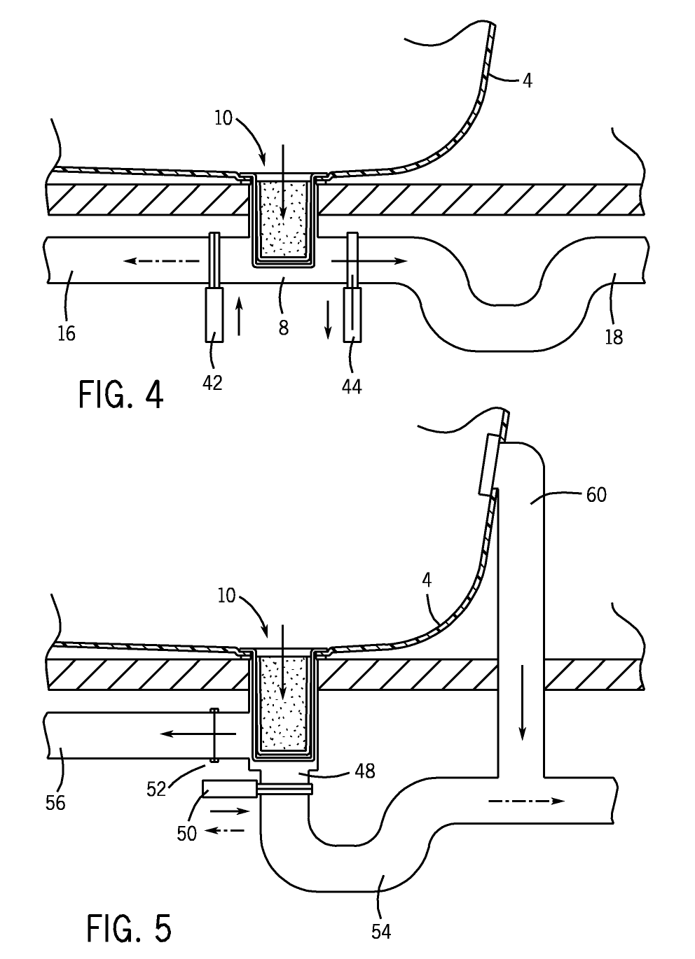

FIG. 4 illustrates an embodiment of the invention using the filter assembly [10] and valves [42] and [44] In this embodiment the filter holder [20] is used to stabilize the filter [12] but not divert the water. Therefore, the filter holder [20] is an optional component in this embodiment and no extension is needed. However, the filter holder [20] may be used to lend stability to the filter [12] against the rush of water flowing through the opening [2] and pipe [6]. The water, instead, is diverted by the coordinated use of two valves [42] and [44] in drain pipe [8]. These valves can be of any type known by an average skilled practitioner in the industry, including but not limited to ball valves, plug valves, gate valves and butterfly valves. Control of such valves are well-known and may include, but are not limited to manual manipulation with a handle, wheel or knob; electromechanical manipulation with an electric motor or solenoid; or pneumatic or hydraulic actuators. When one valve is opened [44], the other valve is closed [42], the water flows through the channel [18] associated with the open valve [44]. By reversing the open and closed status of the valves, the water reverses flow and flows through channel [16].

In FIG. 5, an embodiment of the system according to the invention is shown using the filter assembly [10], a check valve [52], and a single valve [50] in drain pipe [48]. Herein, a check valve is any pressure sensitive barrier, including but not limited to a flap, gate, diaphragm valve, ball check valve, diaphragm check valve, swing check valve, clapper valve, stop-check valve, lift-check valve, double check valve or any other such device that prevents the flow of fluid in one direction until it is opened by sufficient pressure. The valve [50] is placed in such a way that when open, the water substantially flows through the channel [54] containing the valve [50], but when the valve [50] is shut, the water is forced into the other channel [56]. Little or no water should flow through the channel [56] when the valve [50] is open. This may also be accomplished by providing a sharp incline to channel [56] so that the water would flow counter to gravity to flow through that pipe [56]. The water is only forced up the incline when the valve [50] is closed. In the alternative, there may be a check valve [52] present in the channel [56]. The check valve [52] would be closed when the water pressure is equal or less than the water pressure occurring when the valve [50] is open. However, when the water pressure increases due to the valve [50] closing, the check valve [52] opens to allow water to flow through the second channel [56]. When the water pressure again decreases, whether due to the valve [50] opening or water no longer flowing, the check valve [52] closes. The check valve [52] and valve [50] can be of any type and controlled by any means known by an average skilled practitioner in the industry.

Also shown in FIG. 5 is the placement of an overflow pipe [60] from the fixture [4] to the channel [54]. In FIG. 5, the overflow water bypasses the filter assembly [10] allowing the overflow water to always flow to a specific location, whether that is a reservoir, septic system, or other waste water location. By simply shifting the location of the valve [50] to a location downstream from the overflow pipe [60], the overflow water can also be diverted. This same shifting of the valve [50] also works in the embodiment shown in FIG. 4 to allow overflow diversion in that embodiment.

| | |
|---|---|
| 2 | Fixture opening |
| 4 | Fixture |
| 6 | Fixture outlet drain 1 |
| 8 | Drain pipe |
| 10 | Filter apparatus |
| 12 | Filter basket |
| 14 | Gasket |
| 16 | Channel 1 |
| 18 | Channel 2 |
| 20 | Filter holder |
| 22 | Filter holder lip |
| 24 | Filter holder wall |
| 26 | Filter holder floor |
| 28 | Filter holder solid section |
| 30 | Filter holder open section |
| 32 | Extension |
| 34 | Pipe divider |
| 36 | |
| 38 | |
| 40 | |
| 42 | Valve 1 |
| 44 | Valve 2 |
| 46 | |
| 48 | Fixture outlet drain 2 |
| 50 | Valve 3 |
| 52 | Check valve |
| 54 | Channel 3 |
| 56 | Channel 4 |
| 58 | |
| 60 | Overflow pipe |
| 62 | |
| 64 | |
| 66 | |
| 68 | |
| 72 | |
| 74 | |
| 76 | |
| 78 | |
| 80 | |
| 82 | |
| 84 | |
| 86 | |
| 88 | |
| 100 | |
| 102 | |
| 104 | |
| 106 | |
| 108 | |
| 110 | |
| 118 | |
| 120 | |
| 122 | |
| 124 | |
| 126 | |
| 128 | |
| 130 | |
| 132 | |
| 140 | |
| 142 | |
| 144 | |
| 146 | |
| 148 | |
| 150 | |
| 152 | |
| 160 | |
| 162 | |
| 164 | |
| 166 | |
| 168 | |
| 170 | |
| 172 | |

I/we claim:

1. A system for diverting water comprising:
a) a filter basket;
b) a drain pipe providing a first channel and a second channel; and
c) a diverter capable of diverting water from the filter basket alternatively towards each of the first and second channels.

2. The system of claim 1, where the diverter comprises a solid-walled cup with an extension that spans the cross-section of the drain pipe such that when the extension is perpendicular to the drain pipe, water flows substantially towards only one channel in the drain pipe.

3. The system of claim 1, where the diverter comprises a solid-walled cup with an extension and a divider in the drain pipe directly beneath the filter basket such that when the extension is perpendicular to the pipe, the divider and the extension cooperate to divert water substantially towards only one channel in the drain pipe.

4. The system of claim 1, where the diverter comprises a first valve that regulates water flow to the first channel and a second valve that regulates water flow to the second channel such that only one valve is open at a given time so that water can substantially flow towards only one channel in the drain pipe at a given time.

5. The system of claim 1, where the diverter comprises a valve in the drain pipe that directs water towards the first channel when closed, and directs water substantially towards the second channel when open.

6. The system of claim 5, where a check valve in the first channel excludes water in the first channel when the valve is open.
